(19) United States
(12) Patent Application Publication
(10) Pub. No.: US 2021/0385198 A1
(43) Pub. Date: Dec. 9, 2021

(54) COMPUTING SYSTEM WITH INTELLIGENT DATA PROVENANCE

(71) Applicant: Seagate Technology LLC, Fremont, CA (US)

(72) Inventor: Nyuk Fah Alice Lee, Florissa Park (SG)

(21) Appl. No.: 16/946,084

(22) Filed: Jun. 5, 2020

(51) Int. Cl. H04L 29/06; G06F 16/23

(52) U.S. Cl. CPC H04L 63/0428; G06F 16/2365

(57) ABSTRACT

A computing system can engage in intelligent data provenance with a data storage device connected to a host as part. The data storage device can have a provenance module that employs a trust circuit to maintain a chain of title ledger where the chain of title ledger logs a provenance of the data storage device since the data storage device was manufactured.

### SUMMARY

A computing system, in accordance with various embodiments, has a data storage device connected to a host as part of a distributed computing system with the data storage device having a provenance module with a trust circuit configured to maintain a chain of title ledger that logs a provenance of the data storage device since the data storage device was manufactured.

Some embodiments of a computing system install a data storage device into a distributed computing system and then restrict data communication to the data storage device. A chain of title ledger is consulted with a trust circuit of a provenance module of the data storage device with the chain of title ledger logging a provenance of the data storage device. The provenance of the data storage device is verified with the trust circuit in response to consulting the chain of title ledger and a trusted data pathway is formed with at least one component of the distributed computing system in response to the provenance being attested by the trust circuit.

In other embodiments, a computing system installs a data storage device into a distributed computing system and then restrict data communication to the data storage device. A chain of title ledger is consulted with a trust circuit of a provenance module of the data storage device with the chain of title ledger logging a provenance of the data storage device. The provenance of the data storage device is verified with the trust circuit in response to consulting the chain of title ledger and a trusted data pathway is formed with at least one component of the distributed computing system in response to the provenance being attested by the trust circuit. The trusted data pathway is used to transfer data and a provenance strategy is generated with the provenance module prior to being executed to detect a third-party attack on the data storage device.

### BRIEF DESCRIPTION OF THE DRAWINGS

FIG. 1 is a block representation of an example computing system in which assorted embodiments can be practiced.

FIG. 2 depicts portions of an example computing system operated in accordance with assorted embodiments.

FIG. 3 depicts a timeline representing operation of an example computing system in accordance with various embodiments.

FIG. 4 depicts example portions of a computing system that can be employed in a computing system in accordance with assorted embodiments.

FIG. 5 depicts a flowchart of an example provenance routine that can be executed in accordance with some embodiments in a computing system.

FIG. 6 provides a flowchart of an example provenance strategy routine that carried out with the assorted embodiments of a computing system.

### DETAILED DESCRIPTION

The present disclosure is generally directed to a computing system, such as a network of distributed data storage, that employs intelligent provenance to optimize the security and integrity of the computing system.

Increasing amounts of data are being generated, transferred, and stored. Data storage aspects of computing systems have evolved to provide greater data capacity with adequate data access speed. However, the greater volume of data storage capabilities in a computing system increases the risk of security vulnerabilities that can result in breaches of data, and component, integrity. For instance, the connection of higher numbers of data storage devices to provide large data storage capacity can provide more opportunities for third-party attacks that jeopardize data and the operation of portions of a computing system.

The greater susceptibility to threats for a computing system can be met with a variety of reactive actions that seek to secure data and data storing components. However, the sophistication of third-party attacks can result in security breaches that are undetected and compromise the security of a computing system over time. Accordingly, various embodiments are directed to establishing provenance for data and data storage aspects of a computing system intelligently in order to establish truly secure system security that adapts to the modularity of modern data storage.

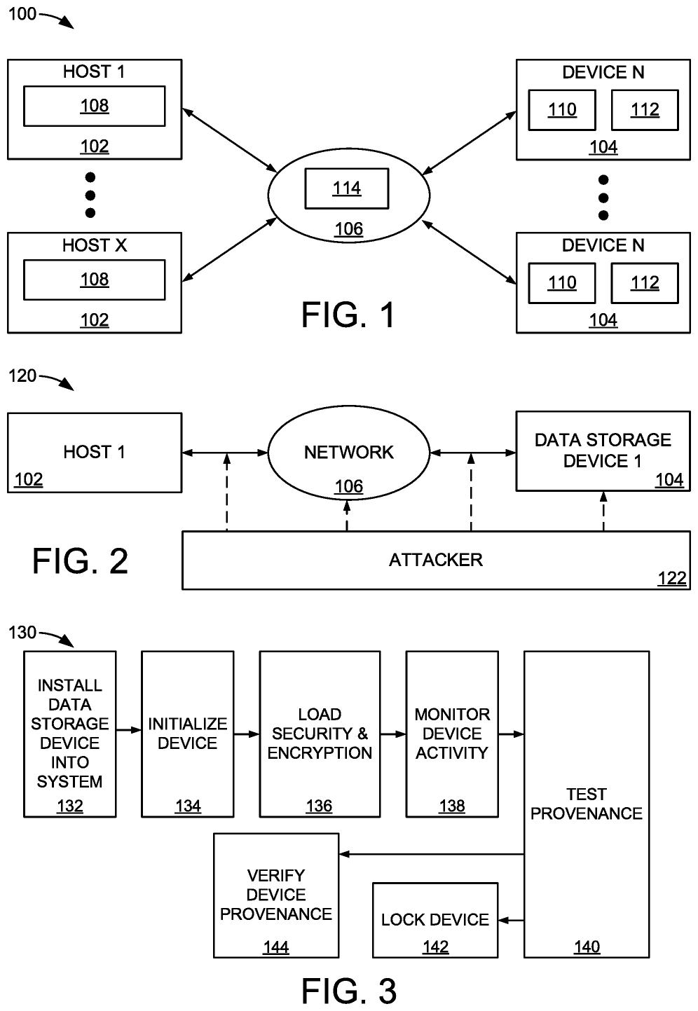

FIG. 1 depicts a block representation of an example computing system 100 in which assorted embodiments can be practiced. The system 100 is arranged as distributed data storage that connects any number (X) of hosts 102 with any number (N) of data storage devices 104 via a network 106. A host 102 can have one or more controllers 108 that generate data and/or data access requests, such as processor, controller, virtual machine, app container, or software, connected to the data storage devices(s) 104 via one or more wired, and/or wireless, signal pathways.

A data storage device 104 may have one or more controllers 110 that direct the flow of data to, and from, non-volatile memory 112, such as a rotating magnetic media, solid-state array, or a combination thereof. It is contemplated that multiple data storage devices 104 are physically positioned within a single rack with some network 106 equipment, such as a server or switch. Such condensed physical footprint for multiple data storage devices 104 can provide efficient physical access and large data capacity, but can introduce a number of opportunities for third-party attacks.

The condensing of signal pathways through a network controller 114 of the network 106, regardless of the physical location of the respective data storage devices 104, can create a security bottleneck where third-party attackers can attain access to large volumes of system 100 information and data. The securing of network controller 114 currently consumes relatively large volumes of computing power and processing that results in degraded data storage performance compared to if no security measures were present. While reactive actions may be undertaken once a threat or attack is detected, a system 100 administrator has, in the past, had to choose between heightened security with slower data storage performance or lower security with heightened data storage performance.

FIG. 2 depicts a block representation of portions of an example computing system 120 where a third-party attacker 122 is attempting one or more attacks. As shown by segmented lines, the attacker 122 can attempt to enter the system 120 at several different locations, which may correspond with different times during the initialization of a data storage device 104, the satisfaction of a data access request to the data storage device 104, or the execution of background system operations in any component of the system 120. An attack, as illustrated by segmented lines, is contemplated to occur in susceptible system locations, such as upstream of network 106 distribution, downstream of network 106 distribution, and at a data storage device 104 itself. It is contemplated that an attack may take many different forms that are directed to copying, altering, or hijacking data, commands, security data, and/or other information that allows the attacker 122 to access and/or control portions of the system 120 in the future.

In a non-limiting example, an attacker 122 can initially gain system 120 information that allows for future access to firmware of the data storage device 104 where the attacker 122 can manipulate control, security policies, and other administrative functions that compromise the integrity and reliability of data stored in the data storage device 104 as well as other connected devices 104 of the system 120. Another example attack results in providing the attacker 122 with trusted status that allows access to existing and future data. Hence, an attacker 122 can utilize detectable and/or undetectable monitoring of power, signals, commands, power cycles, and initializations to reconstruct information, such as firmware, encryption, and settings, that allow the attacker 122 access to some, or all, of the system 120 over time.

These attacks are in no way limiting, but illustrate how an attacker 122 can infiltrate and compromise an entire computing system 120 with access to relatively small portions of the system 120 that can be detectable or undetectable to the system 120 as a whole as well as to individual components of the system 120. Such risk to data, data storage devices 104, and network nodes posed by third-party attackers 122 has prompted the integrity of system 120 components to be verified during initialization into the system 120 and at times thereafter.

FIG. 3 depicts a timeline of an example computing system provenance process 130 that can be conducted on the computing systems 100/120 of FIGS. 1 & 2 in accordance with various embodiments. Upon the physical installation of a data storage device into a computing system in step 132, the device begins to initialize by conducting at least one boot operation in step 134. The physical installation of the data storage device can be conducted with other aspects of the computing system being operational and active in satisfying data access requests. It is contemplated that the physical installation in step 132 can involve the connection of one or more busses or ports that provide power and data signal pathways.

The device initialization of step 134 can involve installing, activating, and/or completing one or more processes aimed at taking the device from an inoperable state to an operable state with respect to the system. That is, step 134 may conduct operations that bring software, firmware, and settings congruent to the connected computing system. While the initialization of step 134 may involve the initialization of security and encryption aspects, process 130 specifically conducts one or more activation operations for the newly installed device in step 136. Such activation operations can result in the data storage device communicating keys, certificates, passwords, and other information with other aspects of the computing system to attain a verified and secure status where the accepted and secure security/encryption information is used. It is contemplated that portions of step 136 are conducted solely in the device without communication with other aspects of the system, such as in a self-encrypting drive.

At the conclusion of steps 134 and 136, the data storage device is active and capable of conducting data storage and retrieval activity in accordance with the security, encryption, and background system operations directed by upstream network aspects. The activity and operation of the data storage device is subsequently monitored in step 138. The monitoring of step 138 may be continuous, sporadic, or reactionary and can produce a log of activity that can be analyzed in step 140 to detect successful and unsuccessful third-party attacks.

For instance, power consumption may be monitored and analyzed to detect patterns associated with security and/or encryption operations that could be inspected by third-parties to reconstruct security and/or encryption information that can be used to gain access to the data storage device, network, and data stored therein. As another example, firmware access attempts can be monitored in step 138 so that step 140 can determine a third-party attack was successful or unsuccessful. The ability to log and analyze a diverse variety of information about data storage operations allows conclusions about third-party attacks to be increasingly accurate compared to the analysis of a single data storage device activity metric, such as power consumption, firmware accesses, data access frequency, incorrect encryption key attempts, and password delay.

In the event a successful third-party attack is detected in step 140, step 142 can lock the data storage device, or other infiltrated system component, to prevent further system infiltration. The locking of a device/component may be temporary or permanent and can involve one or more restoration operations aimed at re-establishing a secure and verified operational status for the device/component. It is contemplated that step 142 engages in one or more alterations to the security protocol of the system/device in an attempt to prevent third-party attacks in the future.

Once step 140 determines no third-party attacks have infiltrated the data storage device or other system component, step 144 certifies the provenance of the device as trustworthy and secure. However, such provenance can only be assured since the initialization of the data storage device into the computing system in steps 134 & 136. As such, the provenance operations of process 130 are forward-facing and only certify trustworthy provenance from the most recent initialization of the data storage device. While the provenance provided in step 144 can be useful, it leaves the data storage device vulnerable. For example, third-party attacks that survive a power cycle and initialization of a device, such as attacks that simply relay activity, operations, security information, and/or encryption information to a third-party without altering anything directly.

Accordingly, embodiments of a computing system are directed to a rear-facing provenance that intelligently detects successful and unsuccessful third-party attacks from the date a data storage device was manufactured and released for consumer use. That is, rear-facing provenance can establish a trusted chain of title and trust from the time non-manufacturing and testing activity was conducted on a data storage device. The ability to construct, test, and verify the trustworthiness of a data storage device from manufacture regardless of how many systems, initializations, and power cycles have been conducted allows a computing system to rely on the device for current and future security and encryption operations.

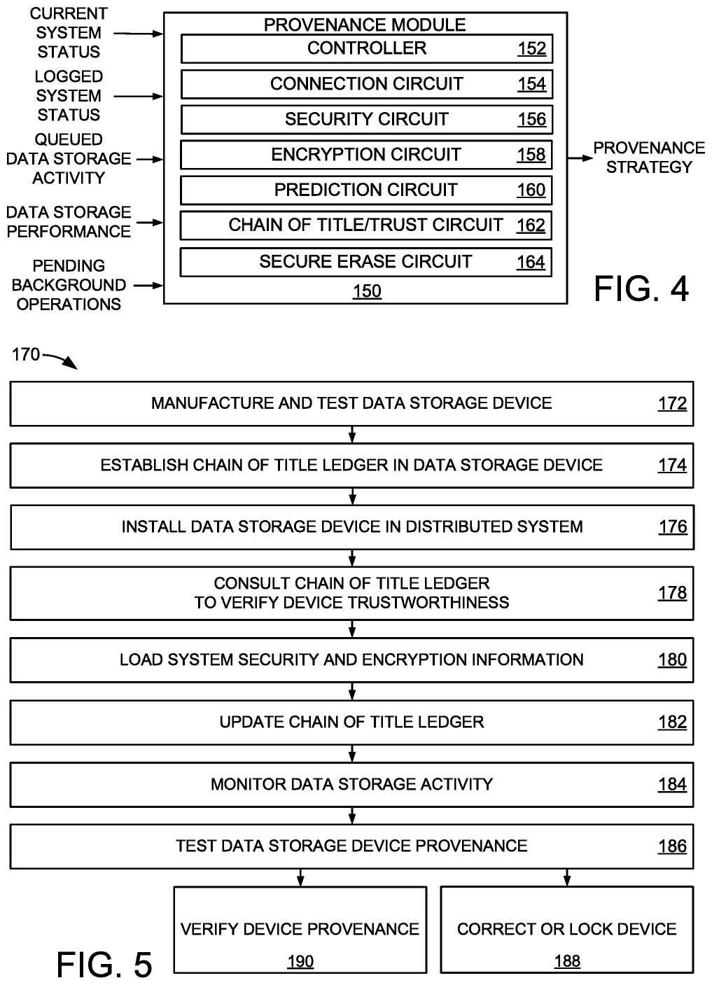

These embodiments can be realized in hardware and software via a provenance module 150 that is generally displayed in block form in FIG. 4. The provenance module 150 can utilize one or more controllers 152 to provide top-level organization and execution of various tasks, commands, maintenance, and requests. The controller 152 may physically be resident in any location within a distributed data storage system. For instance, a module controller 152 may be a stand-alone component that only serves provenance module 150 operation, a shared controller of a data storage device 104, a shared controller of a network node, or a shared controller of a host. The ability to utilize a stand-alone or shared controller 152 for provenance module 150 purposes allows the module 150 to be implemented in any aspect of a distributed computing system without adding undue complexity and/or physical burden.

The module controller 152 can activate a connection circuit 154 that monitors the electrical and/or data pathways established and disconnected over time. The connection circuit 154 can direct the initialization and usage of a connection between a data storage device and another component of a distributed system. Likewise, the connection circuit 154 can terminate a connection with another component of a distributed system when the controller 152 deems appropriate, such as after a predetermined amount of time, a malicious attack threat, an efficient connection, or an unstable data pathway. The connection circuit 154, in some embodiments, tests a connection to a data storage device for efficiency and logs the connection activity in order to construct a historical log of what connections have been attempted and established to a particular data storage device.

A security circuit 156 can be employed by the provenance module 150 to carry out protocol associated with verifying a potential data storage device connection, securely initializing a data pathway, and securely moving data along that data pathway. The security circuit 156 can update security credentials, such as passwords, certificates, keys, and challenges, over time to reduce the risk of such credentials being copied or stolen. It is contemplated that the security circuit 156 monitors data storage device activity to detect attempted and successful third-party attacks on a data storage device. The security module 156 can react to such detected attacks with one or more mitigation schemes that alter security credentials, the flow of data to/from a data storage device, or data pathway connections with one or more identified suspicious distributed network actors.

The security circuit 156 can be complemented by an encryption circuit 158 that generates and utilizes one or more data coding schemes to increase the security of the data, and system. In practice, the encryption circuit 158 can be the engine that actually changes security credentials and/or data handling security as directed by the security circuit 156. The encryption circuit 158 may increase, or decrease, the degree of encryption for data, system signals, and system information to balance a risk of successful third-party attack with data storage efficiency. That is, the encryption circuit 158, in concert with the security circuit 156, can dynamically adjust the encryption scheme, such as 16-bit to 32-bit, type of encryption, or use of hash values, with respect to the performance impacts to at least data writing and data reading latency, which can be defined as data storage efficiency.

While the connection circuit 154, security circuit 156, and encryption circuit 158 can respectively operate to carry out real-time and/or reactive data storage device operations, such as data storage, data retrieval, and background device activity, various embodiments utilize the provenance module 150 to conduct proactive data storage device operations based on one or more forecasted events, actions, or occurrences. Hence, a prediction circuit 160 can provide the provenance module 150 with one or more predicted future device conditions from at least inputted current system status data, previous device status data logged by the provenance module 150, current queued data storage activity, current and past data storage performance, and pending device background operations.

Although other current and past system and data storage device information can be utilized by the prediction circuit 160, the inputs shown in FIG. 4 can allow the prediction circuit 160 to accurately forecast one or more actions, events, and occurrences that can jeopardize the integrity of a data storage device, the distributed system, and data storage therein. It is contemplated that the prediction circuit 160 may further compute how hypothetical proactive actions will result in altering future data storage performance in relation to a risk of successful third-party attacks to the system. For example, the prediction circuit 160 can generate multiple different proactive actions, such as changing security credentials, moving the storage location of security credentials, or altering device initialization and handshake protocol, and accurately forecast how implementation of those assorted actions will modify data storage performance and risk of third-party attacks.

The ability to predict future data storage and third-party attack activity can be useful in generating a provenance strategy that predetermines a number of different reactionary and proactive measures that can be taken upon detected device and/or system activity. That is, the respective circuitry of the provenance module 150 can individually, and collectively, assess current inputs, historical data, and predicted actions, events, and occurrences to create a provenance strategy that prescribes reactive and/or proactive activity to ascertain, monitor, and maintain a trusted and secure data storage provenance. The provenance strategy may, in some embodiments, prioritize activity to verify and secure provenance of the data storage device over data storage performance, security measures to prevent third-party attacks, or both. The use of reactive and/or proactive actions to maintain trustworthy provenance of the data storage device allows the device to survive power cycles, firmware updates, and other activity involving new initialization of data storage device hardware and/or software.

In accordance with various embodiments, the provenance of a data storage device is established, tested, verified, monitored, and maintained by a trust circuit 162 of the provenance module 150 that keeps a secure chain of title ledger for the device. It is noted that chain of title logging can be conducted from each new device initialization or power cycle, but such chain of title are succinctly susceptible to third-party attacks that survive a device's power cycle/initialization, such as Trojan horse-type attacks that are stored in the device unexpectedly or simply broadcast signal and data activity without altering aspects of the device's operation or credentials. Hence, the trust circuit 162 is configured to establish a chain of title for the data storage device since the device was introduced for use from the manufacturing.

To be clear, the trust circuit 162 can verify, update, and generate a chain of title for the data storage device since the device left a manufacturer and the quality and reliability testing involved therein. It is contemplated that the manufacturer initially sets a chain of title ledger with secure information unique to the particular data storage device, such as information from manufacturer testing, physical attributes of internal device components, or operating parameters unobtainable unless manufacturer testing was conducted again. For instance, secure unique information from the manufacturer that begins a secure chain of title ledger can be a number of manufacturer testing cycles conducted, temperature range of manufacturer testing conducted, pass/fail ratio of the device for assorted tests during manufacturer testing, initial voltage calibration of a data storage cell, average test fly height experienced during testing, size of a test data block written during manufacturer testing, device component serial numbers, device component physical range of motion, or device component physical resonance frequency.

Regardless of the number and type of secure unique device information used to initially generate a chain of title ledger at the manufacturer, the trust circuit 162 is the only hardware that can access, read, and modify the ledger. That is, the chain of title ledger is stored in the data storage device in a manner that the trust circuit 162 of the particular device is the only hardware or software that can access or modify the ledger. As such, the chain of title ledger is maintained as secure and trustworthy due to the contents of the ledger never being communicated outside of the data storage device. Thus, a third-party infiltration of the data storage device could not corrupt, copy, or delete the chain of title ledger without sophisticated knowledge of the security, encryption, and provenance strategy of the device designed to separate and elevate the chain of title ledger in terms of reliability and trustworthiness.

The elevation of security measures for the chain of title ledger can be prescribed by the provenance strategy and may involve extra encryption, increased encryption protocol, and insolating access to the ledger by any hardware or software of the data storage device for a period of time. The provenance strategy may prescribe the chain of title to be moved, scrambled, split apart, or randomized in response to a detected, or predicted, malicious attack, device initialization, or suspicious pattern of firmware updates/accesses.

With the provenance strategy set prior to chain of title ledger needing modification or elevated security, the trust circuit 162 can carry out prescribed measures more efficiently than if the provenance module controller 152 reacted to detected device activity and events by generating reactive and/or proactive actions. In other words, the preexistence of ledger measures in the provenance strategy allows the measures to be executed quicker and with less processing overhead than if the measures were generated in real-time in response to actual and/or potential threats to the ledger. Accordingly, the security and integrity of the chain of title ledger can be maintained despite dynamic data storage device activity and threats.

The trust circuit 162 can operate to verify the chain of title continuously, routinely, or randomly by matching the secure chain of title ledger with the log of connections, security credentials, firmware versions, and any other data storage device activity. The matching of the secure ledger information with device activity logged by the provenance module 150 ensures the logged activity has not been tampered with and the ledger has remained secure. As a result, the chain of title can be reliably verified from device manufacture to the current date. It is contemplated that the trust circuit 162 may conduct one or more verifying activities, such as storing false information in the ledger, matching the physical storage location of the ledger, or multi-level challenge queries, to attest the genuine trustworthiness of the ledger.

Through the provenance strategy and assorted provenance module 150 activity directed at ensuring the source and content of the chain of title ledger, the module controller 152 can rely on the ledger information for security, encryption, and provenance attestation. Over time, the provenance module 150 may update the information in the ledger as device activity dictates, such as firmware updates, establishment of new network connections, receipt of data pathway, and device power cycle. The trust circuit 162 can conduct secure ledger additions, as directed by the module controller 152, to update of such device activity. It is noted that the provenance module 150 can restrict the modification and removal of information in the ledger to allow only information additions, which further ensures the information of the ledger being accurate, genuine, and unaltered.

A secure erase circuit 164 of the provenance module 150 can carry out a variety of operations to utilize the chain of title ledger to completely erase data, settings, credentials, and information from any device of a distributed network. In one embodiment, the secure erase circuit 164 uses a chain of title to remove user data, background data, or metadata by deriving a random encryption that makes such data unreadable. That is, the chain of title ledger information can be used by the secure erase circuit 164 to generate a data encryption to modify data without a key. The fact that the chain of title ledger information is secure and reliable over time causes such data encryption to be secure as the encrypted data cannot be retrieved unless the ledger information was known along with the type of encryption.

The secure erase circuit 164 may further erase an entire device by self-encrypting a chain of title ledger. Such self-encrypting may involve moving some, or all, of the physical data storage location of the chain of title ledger. Self-encrypting may also involve writing false information into the ledger to ensure future verifications of the ledger will return an error that results in no data storage activity, device initialization, or background operations to be approved by the provenance module 150. By utilizing the secure chain of title ledger, the secure erasure circuit 164 can efficiently render portions of data inaccessible, corrupt, and practically non-existent.

Just as the secure erase circuit 164 can employ a chain of title ledger to render data and devices inoperable, the provenance module 150 may utilize a ledger to secure other devices and/or data. The protected, reliable, and trustworthy information of a ledger can be used to generate new or additional encryption keys that can provide heightened security for a device and the data stored therein. The fact that one data storage device's chain of title information is used to derive encryption and/or security information for a different connected data storage device further separates lock and key to provide greater protection against third-party attacks by increasing the amount of information needed to hack, or recreate, an encryption or security credential.

The provenance module 150 can be utilized in a variety of manners to provide intelligent rear-facing provenance for a data storage device. Non-limiting provenance routine 170 shown in FIG. 5 conveys how a manufacturer generated chain of title ledger can be used to attest device provenance since the device left custody of the manufacturer. Upon a data storage device being manufactured in step 172, the device is tested, which can involve the assembly, activation, and execution of data reads and writes of manufacturer-generated data. Once the data storage device passes testing and is approved for consumer use, step 174 establishes a secure chain of title ledger with a provenance module of the data storage device as the only steward of the ledger.

While not required or limiting, the chain of title ledger created in step 174 with device information unique to the particular data storage device, such as testing information, testing results, and/or device structural information. For instance, an average temperature for the data storage device during testing, number of testing cycles conducted on the device, amount of device storage capacity utilized during testing, or physical location of temporary testing data stored during testing can be used alone, or in combination to create initial ledger entries that allow the provenance module to efficiently verify the ledger as genuine and trustworthy at a later date.

The chain of title ledger may lie dormant until the data storage device is installed into a distributed computing system in step 176. It is contemplated that the data storage device is connected to a single host in step 176, but such connection configuration is not limiting. The establishment of a connection between the data storage device and any number of hosts, nodes, and other storage devices of the computing system triggers step 178 to consult the chain of title ledger to verify the trustworthiness of the data storage device from the date of manufacture. The activity of verifying the device from the chain of title ledger rests on the provenance module of the data storage device being verified.

While not limiting, step 178 can attest the provenance of the data storage device since manufacture by conducting one or more tests, such as matching some, or all, of the entries of the ledger against a log maintained by the provenance module of the past connections, data sources, security updates, and third-party attacks. The ability to certify the data storage device's provenance via the chain of title ledger since manufacture allows the provenance module to approve, or deny, the connection of the device to the computing system. That is, the provenance module may deny a data pathway connection to, or from, the data storage device in response to the chain of title ledger being different than the log of device activity stored in the provenance module.

However, if consulting the chain of title ledger attests the device's provenance, step 180 is triggered to allow communications with the system to load security and encryption information that allows the data storage device to conform to the system's protocol and procedures. The new connection is then logged in the secure chain of title ledger in step 182 by the provenance module by adding a new entry. The data storage device can then be employed in any data storage operation by the connected computing system. The activity of the device is monitored in step 184 for potential and actual malicious threats as well as for unsuccessful and successful third-party attacks.

At scheduled times, or in response to a detected or predicted threat or attack, step 186 can test the provenance of the device to ensure an attack has not been successful and undetected. The test of step 186 can involve verifying the current operating, security, and encryption aspects of the data storage device are sourced from known genuine sources that have been logged in the chain of title ledger. If something in the data storage device has an unknown origin that does not match the chain of title ledger, step 188 can take one or more corrective actions, such as purging data, quarantining sections of the data storage device, and reverting back to a known genuine device state.

Step 188 may lock the data storage device without attempting corrective measures or if executed measures do not place the entirety of the data storage device in a state where all aspects have known genuine sources. In the event the testing of the device's provenance in step 186 proves that all aspects have known genuine sources, step 190 verifies the device's provenance, which can correspond with increased connectivity, greater security priority, and derivation of security measures for other system components based on the chain of title for the data storage device. Through the maintenance and utilization of a secure chain of title ledger, a data storage device can have provenance from manufacture attested at any time and the source of data, security credentials, encryption information, and software can be verified so that a third-party attack is immediately discovered and mitigated without spreading to other components of the computing system.

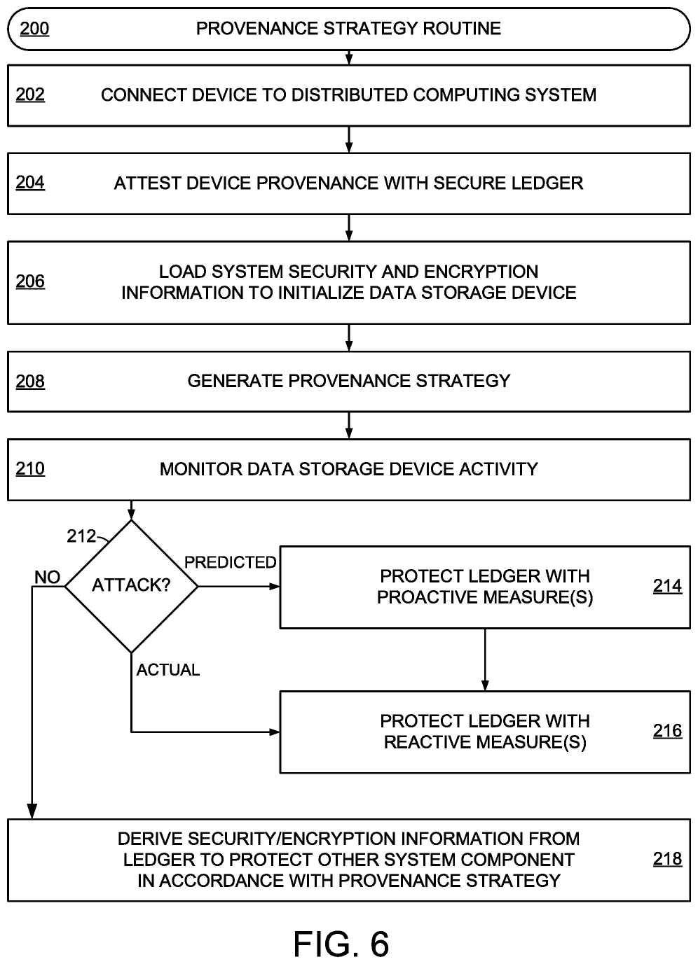

The provenance module 150 of a data storage device is not limited to managing a chain of title ledger and can provide a diverse array of capabilities through the execution of one or more provenance strategies. Routine 200 of FIG. 6 illustrates how a provenance module of a data storage device can be employed to provide intelligent and dynamic device handling of predicted and actual malicious third-party attacks. Initially, step 202 connects a data storage device to a distributed computing system, such as system 100 of FIG. 1. The data storage device is expected to have a secure chain of tile ledger installed at the conclusion of manufacturing that is tied to a provenance module of the device.

Upon detection of the connection to one or more distributed system components, the provenance module attests the provenance of the data storage device by verifying the contents of the chain of title ledger in step 204. For instance, step 204 can guarantee the data storage device has not been infiltrated by a third-party attacker, or prove that an attack has infiltrated the device, by consulting the chain of title ledger entries that convey each connected component, source of data, source of security credentials, and source of encryption information. Hence, the maintenance of the chain of title ledger by the provenance module to securely log the connection, data, security, and encryption activity of a data storage device allows step 204 to identify that each connected source of data, credentials, and information has been genuine, accepted, and trusted.

The attestation of the provenance of the data storage device in step 204 allows step 206 to begin communicating with system components to establish security, encryption, and operating protocol for the data storage device that are congruent with the distributed computing system. As an example, step 206 can download encryption keys, firmware, and data mapping tables shared by other data storage devices of the system. It is noted that the data storage device may employ self-encryption where encryption information shared by other devices of the system are ignored.

The connection of the data storage device triggers the initialization of the device, which can involve any number of processes to transition the device from an inoperable state to a state where data access operations and background operations can be conducted. Such initialization may involve a power cycle, software boot, physical memory testing and calibration, writing data, and populating buffer memory to allow the data storage device to satisfy data access requests from remote system components in real-time.

An initialized data storage device may operate for any amount of time to service any number of data access requests before the provenance module generates a provenance strategy in step 208. A generated provenance strategy can derive from model data from other data storage devices, logged activity and data storage performance from a particular device, as well as pending activity for the particular device. Regardless of the information used to generate the provenance strategy, the strategy can prescribe an assortment of proactive and reactive measures that are triggered by various detected and/or predicted events. The provenance strategy can have measures directed at protecting the chain of title ledger, such as adding security challenges, altering encryption settings, or moving some or all of the ledger to a different physical location, in response to a detected attack, attempted attack, or susceptibility to attack predicted by the provenance module.

The provenance strategy can have measures directed at mitigating the damage a successful third-party attack can inflict, such as restricting access to non-volatile memory, reverting firmware to a known trusted version, suspending data connections with other system components, and encrypting sensitive data and security information. Another possible purpose of the provenance strategy can be to intelligently test the data storage device for susceptibilities to third-party attacks by engaging in test activity that simulates how an attempted attack would be handled by the current data storage device, as forecasted by the prediction circuit of the provenance module. It is contemplated that the provenance module has measures directed to discovering successful third-party attacks that have previously gone undetected, such as issuing deliberately false security information, randomizing power consumption during security sensitive device operations, and sporadically powering the device down to force a reset of various device aspects.

Although a provenance strategy can be modified at any time by the provenance module, the presence of at least one strategy from step 208 allows normal data storage operations to occur in step 210 while being monitored. Decision 212 determines from the monitored data storage device activity if a third-party attack is occurring or is to occur based on a forecasted scenario generated by the prediction circuit of the provenance module. A predicted third-party attack or other malicious threat to the integrity of the data of the data storage device prompts step 214 to execute one or more proactive measures prescribed by the provenance strategy generated in step 208. The measures that can be conducted in step 214 are not limited and can do more than simply alter existing device configuration to proactively protect the chain of title ledger.

As a non-limiting example, step 214 can respond to a predicted attack by adding a security challenge question to read the chain of title ledger along with altering the current encryption key to protect user data stored in the data storage device. The ability to conduct prophylactic measures in response to a predicted threat in accordance with the established provenance strategy ensures that the measures are coordinated and complementary as opposed to redundant and/or inefficient measures, such as uniformly increasing the level of security for all device systems or locking all device function. In other words, the existence of multiple possible proactive measures in the provenance strategy allows step 214 to be executed with intelligence and efficiency as measures can be quickly selected and carried out without having to process current conditions and generate a proactive response.

While preventing attacks and successful threats is the goal of the proactive measures performed in step 214, not all proactive measures prevent an attack or threat. Hence, the detection of an actual attack by the provenance module triggers step 216 to conduct one or more reactive measures to mitigate the damage and scope of the attack. It is noted that the activation of reactive measures in step 216 can follow executed proactive actions in step 214, such progression is not required and no proactive measures are a prerequisite for the execution of reactive measures in accordance with the provenance strategy generated in step 208. A reactive measure may, in some embodiments, encompass suspending one or more data pathways with other aspects of the distributed computing system or terminating any pending accesses to the secure chain of title ledger until the attack is overcome.

The number, type, location, and duration of the reactive measures of step 216 can be dependent on the attack. As such, the reactive measures prescribed by the provenance strategy can be diverse so that a provenance module can select the sequence, frequency, and number of measures needed to successfully eliminate the threat posed by a successful attack. As a result of the measures of step 216, the data storage device can return to normal function as a data repository for the distributed computing system, but may have altered security, encryption, and operational configurations prescribed by the provenance strategy to prevent such attack from successfully breaching the data storage device again.

Various embodiments focus the reactive measures of step 216 on protecting the integrity of the chain of title ledger, which allows the data storage device to simply be reset with a power cycle to eliminate many successful attacks. That is, by keeping the ledger safe and secure, device initialization will subsequently cut off a previously successful attack by resetting security, encryption, and operational configurations. It is noted that a corrupted ledger can jeopardize the ability of the data storage device to reliably be initialized into a distributed system. However, a corrupted ledger may prompt a data storage device to alter the function of the data storage from secure data to non-secure data, such as archival metadata, logs, or expired user data.

In the event no attack is predicted or detected from the activity monitored in step 208, decision 212 executes step 218 where one or more pieces of security and/or encryption information are derived from the secure chain of title ledger for use in protecting other components of the distributed computing strategy. The provenance strategy generated in step 208 can provide predetermined guidance for the derivation and use of information. For instance, the provenance strategy can prescribe different levels of chain of title ledger derivations that provide varying degrees of protection for other components, such as hosts, network nodes, and other data storage devices, but involve differing amounts of processing and time. The ability to consult the provenance strategy for predetermined levels of ledger entry derivation into security credentials, encryption keys, and challenge queries allows the provenance controller to select the derivation to balance the additional protection with the processing and time overhead corresponding with the derivation process.

Through the assorted embodiments of a data storage device employing a provenance module, rear-facing provenance can be efficiently and accurately attested from device manufacture to the present. The generation and intelligent deployment of a provenance strategy allows a provenance module to efficiently protect the data storage device, the user data stored in the device, and the chain of title ledger that enables accurate rear-facing provenance. By maintaining the chain of title ledger, the provenance module can survive data storage device power cycles and device initializations to efficiently detect and eliminate malicious threats and third-party attacks.

It is to be understood that even though numerous characteristics of various embodiments of the present disclosure have been set forth in the foregoing description, together with details of the structure and function of various embodiments, this detailed description is illustrative only, and changes may be made in detail, especially in matters of structure and arrangements of parts within the principles of the present technology to the full extent indicated by the broad general meaning of the terms in which the appended claims are expressed. For example, the particular elements may vary depending on the particular application without departing from the spirit and scope of the present disclosure.

What is claimed is:

1. An apparatus comprising a data storage device connected to a host as part of a distributed computing system, the data storage device comprising a provenance module with a trust circuit to maintain a chain of title ledger logging a provenance of the data storage device since the data storage device was manufactured.

2. The apparatus of claim 1, wherein the provenance comprises each source of data external to the data storage device.

3. The apparatus of claim 1, wherein the provenance comprises each connection between the data storage device and an external computing component.

4. The apparatus of claim 1, wherein the provenance comprises each source of security credentials external to the data storage device.

5. The apparatus of claim 1, wherein the provenance comprises each source of encryption keys external to the data storage device.

6. The apparatus of claim 1, wherein the data storage device is connected to a network controller as part of the distributed computing system.

7. A method comprising:
installing a data storage device into a distributed computing system;
restricting data communication to the data storage device;
consulting a chain of title ledger with a trust circuit of a provenance module of the data storage device, the chain of title ledger logging a provenance of the data storage device;
verifying the provenance of the data storage device with the trust circuit in response to consulting the chain of title ledger; and
forming a trusted data pathway with at least one component of the distributed computing system in response to the provenance being attested by the trust circuit.

8. The method of claim 7, wherein the trusted data pathway allows data communication with the distributed computing system.

9. The method of claim 7, wherein the trusted data pathway is used to load external security information into the data storage device.

10. The method of claim 9, wherein the trusted data pathway is logged by the trust circuit into the chain of title ledger.

11. The method of claim 7, wherein the trusted data pathway is used to load external encryption information into the data storage device.

12. The method of claim 7, wherein the provenance module restricts the chain of title ledger from being altered other than adding new connections and sources of data external to the data storage device.

13. The method of claim 7, wherein the chain of title ledger comprises a unique initial entry written by a manufacturer of the data storage device.

14. The method of claim 13, wherein the unique initial entry corresponds with a testing parameter conducted on the data storage device prior to the data storage device being released from the manufacturer.

15. The method of claim 14, wherein the testing parameter is a number of testing cycles conducted while the data storage device was in custody of the manufacturer.

16. The method of claim 14, wherein the testing parameter is a pass/fail ratio for multiple tests conducted while the data storage device was in custody of the manufacturer.

17. A method comprising:
installing a data storage device into a distributed computing system;
restricting data communication to the data storage device;
consulting a chain of title ledger with a trust circuit of a provenance module of the data storage device, the chain of title ledger logging a provenance of the data storage device;
verifying the provenance of the data storage device with the trust circuit in response to consulting the chain of title ledger;
forming a trusted data pathway with at least one component of the distributed computing system in response to the provenance being attested by the trust circuit;
transferring data over the trusted data pathway;
generating a provenance strategy with the provenance module; and
executing the provenance strategy to detect a third-party attack on the data storage device.

18. The method of claim 17, wherein the provenance strategy comprises prescribed proactive measures to be executed in response to a third-party attack predicted by a prediction circuit of the provenance module.

19. The method of claim 17, wherein the provenance strategy comprises prescribed reactive measures to be executed in response to a successful third-party attack detected by the provenance module.

20. The method of claim 17, wherein the provenance strategy comprises measures to be executed to prioritize an integrity of the chain of title ledger in response to a predicted, attempted, or successful third-party attack.
